(19) United States
(12) Patent Application Publication
(10) Pub. No.: US 2005/0259552 A1
(43) Pub. Date: Nov. 24, 2005

(54) Method and apparatus for initializing recording films of optical recording medium and optical recording medium

(75) Inventors: Hideaki Miura, Chuo-ku (JP); Jiro Yoshinari, Chuo-ku (JP); Tetsuro Mizushima, Chuo-ku (JP)

Correspondence Address: SEED INTELLECTUAL PROPERTY LAW GROUP PLLC, 701 FIFTH AVE, SUITE 6300, SEATTLE, WA, 98104-7092, US

(73) Assignee: TDK Corporation, Chuo-ku (JP)

(21) Appl. No.: 10/630,476

(22) Filed: Jul. 30, 2003

(30) Foreign Application Priority Data
Jul. 31, 2002 (JP) 2002-223430

(51) Int. Cl. G11B 7/20

(52) U.S. Cl. 369/94

(57) ABSTRACT

A method for initializing recording films of an optical recording medium includes two recording layers each including a recording film and which is formed so that a transparent intermediate layer is interposed between each adjacent pair of the recording layers, by projecting a laser beam whose power can be controlled within a predetermined range onto the recording films and simultaneously crystallizing and initializing the recording films, the method for initializing recording films of an optical recording medium including steps of setting a power of the laser beam and a position of a focus of the laser beam so that energy of the laser beam projected onto each of the recording films is equal to or higher than a minimum initialization energy which can crystallize and initialize the recording film irradiated with the laser beam, and projecting the laser beam onto the recording films of the optical recording medium. According to this method, it is possible to efficiently simultaneously crystallize and initialize recording films of the two recording layers of an optical recording medium with an apparatus of simple structure.

### BACKGROUND OF THE INVENTION

The present invention relates to a method and apparatus for initializing recording films of an optical recording medium and an optical recording medium and, particularly, to a method and apparatus for initializing recording films of an optical recording medium which can efficiently simultaneously crystallize and initialize recording films of a plurality of recording layers of an optical recording medium with an apparatus of simple structure and an optical recording medium adapted so that recording films of a plurality of recording layers can be simultaneously crystallized and initialized.

### DESCRIPTION OF THE PRIOR ART

Optical recording media such as the CD, DVD and the like have been widely used as recording media for recording digital data. Such optical recording media require improvement in ability to record large amounts of data and various proposals have been made in order to increase the data recording capacity thereof. One of these is an optical recording medium having two recording layers and such an optical recording medium has been already put to the practical use as an optical recording medium adapted to enable only data reading, such as the DVD-Video and the DVD-ROM.

An optical recording medium adapted only for reading data and provided with two recording layers is formed by laminating two substrates each having prepits constituting a recording layer on the surface thereof via an intermediate layer.

Further, an optical recording medium having two recording layers has been recently proposed in connection with optical recording media in which data can be rewritten by the user (See Japanese Patent Application Laid Open No. 2001-243655 etc.).

A rewritable type optical recording medium having two recording layers is constituted by laminating recording layers each including a recording film sandwiched between dielectric layers (protective layers) via an intermediate layer.

In the case where data are to be recorded in a rewritable type optical recording medium having a recording film formed of a phase change material, the recording film in a crystal phase is irradiated with a laser beam whose power is modulated so as to be equal to a recording power Pw higher than a reproducing power Pr, thereby heating a region of the recording film irradiated with the laser beam to a temperature equal to or higher than the melting point thereof and the heated region of the recording film is rapidly cooled by modulating the power of the laser beam to equal a base power Ph lower than the recording power Pw. As a result, the region of the recording film irradiated with the laser beam is changed from the crystal phase to an amorphous phase and a record mark is formed in the recording film. Since the reflection coefficients differ between the region of the recording film where the record mark is formed and a blank region of the recording film, data can be reproduced utilizing the difference in the reflection coefficients between the region of the recording film where the record mark is formed and the blank regions.

While the recording film in which no data are recorded thus has to be in a crystal phase, a recording film formed by a sputtering process or the like is in an amorphous phase. Therefore, it is indispensable to crystallize the recording film prior to recording data in the recording film. This process is generally called recording film initialization and when recording film initialization is to be performed, a laser beam is projected onto the recording film in an amorphous phase, thereby crystallizing the recording film.

As a result, the initialization of the recording films of a rewritable optical recording medium having a plurality of data recording layers inevitably takes much longer than in the case of a rewritable optical recording medium having only a single data recording layer.

Therefore, Japanese Patent Application Laid Open No. 9-91700 proposes simultaneous initialization of a plurality of recording films by employing a plurality of heads for projecting a laser beam or employing an objective lens having a very small numerical aperture NA.

However, in order to simultaneously initialize a plurality of recording films in accordance with the methods disclosed in Japanese Patent Application Laid Open No. 9-91700, the structure of the initializing apparatus becomes complicated since a plurality of heads has to be employed or a laser beam of sufficient power cannot be obtained because an objective lens having a very small numerical aperture NA has to be employed. Therefore, it is impossible to simultaneously initialize a plurality of recording films in a desired manner.

### SUMMARY OF THE INVENTION

It is therefore an object of the present invention to provide a method and apparatus for initializing recording films of an optical recording medium which can efficiently simultaneously crystallize and initialize recording films of a plurality of recording layers of an optical recording medium with an apparatus of simple structure and an optical recording medium adapted so that recording films of a plurality of recording layers can be simultaneously crystallized and initialized.

The above and other objects of the present invention can be accomplished by a method for initializing recording films of an optical recording medium including a plurality of recording layers each including a recording film and which is formed so that a transparent intermediate layer is interposed between each adjacent pair of the recording layers, by projecting a laser beam whose power can be controlled within a predetermined range onto the recording films and simultaneously crystallizing and initializing the recording films, the method for initializing recording films of an optical recording medium comprising steps of setting a power of the laser beam and a position of a focus of the laser beam so that energy of the laser beam projected onto each of the recording films is equal to or higher than a minimum initialization energy which can crystallize and initialize the recording film irradiated with the laser beam, and projecting the laser beam onto the recording films of the optical recording medium.

According to the present invention, since the power of the laser beam and the position of the focus of the laser beam are set so that the energy of the laser beam projected onto each of recording films of an optical recording medium is equal to or higher than the minimum initialization energy which can crystallize and initialize the recording film irradiated with the laser beam and the laser beam is projected onto the recording films of the optical recording medium, the plurality of recording films can be simultaneously initialized using a single optical head and it is unnecessary to use an objective lens having a small numerical aperture NA. Therefore, the plurality of recording films of the optical recording medium can be efficiently simultaneously crystallized and initialized with an apparatus of simple structure.

In a preferred aspect of the present invention, the laser beam is focused so that the focus thereof is located in a transparent intermediate layer.

According to this preferred aspect of the present invention, since the laser beam is focused so that the focus thereof is located in a transparent intermediate layer, the laser beam projected onto each of the recording films is defocused. Therefore, since the energy of the laser beam projected onto each of recording films of an optical recording medium can be set to be equal to or higher than the minimum initialization energy which can crystallize and initialize the recording film irradiated with the laser beam, the plurality of recording films of the optical recording medium can be efficiently simultaneously crystallized and initialized with an apparatus of simple structure.

In a further preferred aspect of the present invention, the laser beam is condensed by an objective lens onto a transparent intermediate layer to have a depth of focus D so that d≧λ/NA² is satisfied, where d is a thickness of the transparent intermediate layer, λ is a wavelength of the laser beam and NA is a numerical aperture of the objective lens.

In a preferred aspect of the present invention, the optical recording medium includes a first recording layer formed close to a light incident plane on which the laser beam is impinged, a second recording layer formed far from the light incident plane and a transparent intermediate layer formed between the first recording layer and the second recording layer and the method for initializing recording films of an optical recording medium comprises steps of setting the power of the laser beam and the position of the focus of the laser beam so as to satisfy P_{L0}/A0≧P0 and T×P_{L0}/A1≧P1, where PL0 is the energy of the laser beam projected onto the first recording layer, A0 is an area of a spot of the laser beam projected onto the first recording layer, A1 is an area of a spot of the laser beam projected onto the second recording layer, T is a light transmittance of the first recording layer, P0 is the minimum initialization energy of the laser beam per unit area required for crystallizing and initializing a recording film included in the first recording layer and P1 is the minimum initialization energy of the laser beam per unit area required for crystallizing and initializing a recording film included in the second recording layer, and projecting the laser beam onto the first recording layer and the second recording layer of the optical recording medium.

The above and other objects of the present invention can be also accomplished by an apparatus for initializing recording films of an optical recording medium including a plurality of recording layers each including a recording film and which is formed so that a transparent intermediate layer is interposed between each adjacent pair of the recording layers, by projecting a laser beam onto the recording films and simultaneously crystallizing and initializing the recording films, the apparatus for initializing recording films of an optical recording medium comprising a semiconductor laser adapted for emitting a laser beam and movable in a direction perpendicular to a surface of the optical recording medium, an objective lens for converging the laser beam and a controller for controlling overall operation of the apparatus for initializing recording films of an optical recording medium, the controller being constituted so as to set a power of the laser beam emitted from the semiconductor laser and a position of the semiconductor laser in the direction perpendicular to the surface of the optical recording medium so that energy of the laser beam projected onto each of the recording films is equal to or higher than a minimum initialization energy which can crystallize and initialize the recording film irradiated with the laser beam, and projecting the laser beam onto the recording films of the optical recording medium.

According to the present invention, the apparatus for initializing recording films of an optical recording medium comprises a semiconductor laser adapted for emitting a laser beam and movable in a direction perpendicular to a surface of the optical recording medium, an objective lens for converging the laser beam and a controller for controlling overall operation of the apparatus for initializing recording films of an optical recording medium, and the controller is constituted so as to set the power of the laser beam emitted from the semiconductor laser and the position of the semiconductor laser in the direction perpendicular to the surface of the optical recording medium so that the energy of the laser beam projected onto each of the recording films is equal to or higher than a minimum initialization energy which can crystallize and initialize the recording film irradiated with the laser beam, and projecting the laser beam onto the recording films of the optical recording medium, and, therefore, the plurality of recording films can be simultaneously initialized using a single optical head and it is unnecessary to use an objective lens having a small numerical aperture NA. Therefore, the plurality of recording films of the optical recording medium can be efficiently simultaneously crystallized and initialized with an apparatus of simple structure.

In a preferred aspect of the present invention, the controller is constituted so as to set the position of the semiconductor laser in the direction perpendicular to the surface of the optical recording medium so that the focus of the laser beam is located in a transparent intermediate layer.

According to this preferred aspect of the present invention, since the controller is constituted so as to set the position of the semiconductor laser in the direction perpendicular to the surface of the optical recording medium so that the focus of the laser beam is located in a transparent intermediate layer, the laser beam projected onto each of the recording films is defocused. Therefore, since the energy of the laser beam projected onto each of recording films of an optical recording medium can be set to be equal to or higher than the minimum initialization energy which can crystallize and initialize the recording film irradiated with the laser beam, the plurality of recording films of the optical recording medium can be efficiently simultaneously crystallized and initialized with an apparatus of simple structure.

In a further preferred aspect of the present invention, the semiconductor laser and the objective lens are selected to produce a depth of focus D so that d≧λ/NA² is satisfied, where d is a thickness of the transparent intermediate layer, λ is a wavelength of the laser beam and NA is a numerical aperture of the objective lens.

In a preferred aspect of the present invention, the optical recording medium includes a first recording layer formed close to a light incident plane on which the laser beam is impinged, a second recording layer formed far from the light incident plane and a transparent intermediate layer formed between the first recording layer and the second recording layer and the apparatus for initializing recording films of an optical recording medium further comprises a memory for storing, for each kind of the optical recording media, a light transmittance T1 of the first recording layer, the minimum initialization energy P0 of the laser beam per unit area required for crystallizing and initializing a recording film included in the first recording layer, the minimum initialization energy P1 of the laser beam per unit area required for crystallizing and initializing a recording film included in the second recording layer and a light transmittance T2 of the optical recording medium between the light incident plane and the first recording layer, the controller being constituted so as to set the power of the laser beam emitted from the semiconductor laser and the position of the semiconductor laser in the direction perpendicular to the light incident plane so as to satisfy T2×P/A0≧P0 and T1×T2×P/A1≧P1, where P is the power of the laser beam emitted from the semiconductor laser, A0 is an area of a spot of the laser beam projected onto the first recording layer and A1 is an area of a spot of the laser beam projected onto the second recording layer.

According to this preferred aspect of the present invention, the apparatus for initializing recording films of an optical recording medium further comprises a memory for storing, for each kind of the optical recording media, a light transmittance T1 of the first recording layer, the minimum initialization energy P0 of the laser beam per unit area required for crystallizing and initializing a recording film included in the first recording layer, the minimum initialization energy P1 of the laser beam per unit area required for crystallizing and initializing a recording film included in the second recording layer and a light transmittance T2 of the optical recording medium between the light incident plane and the first recording layer, the controller being constituted so as to set the power of the laser beam emitted from the semiconductor laser and the position of the semiconductor laser in the direction perpendicular to the light incident plane so as to satisfy T2×P/A0≧P0 and T1×T2×P/A1≧P1, where P is the power of the laser beam emitted from the semiconductor laser, A0 is an area of a spot of the laser beam projected onto the first recording layer and A1 is an area of a spot of the laser beam projected onto the second recording layer, and therefore, the recording film included in the first recording layer and the recording film included in the second recording layer can be automatically and simultaneously crystallized and initialized only by inputting the kind of the optical recording medium to the apparatus for initializing recording films of an optical recording medium.

The above and other objects of the present invention can be also accomplished by an optical recording medium comprising a substrate, and a second recording layer including a recording film, a transparent intermediate layer, a first recording layer including a recording film and a light transmission layer on which a laser beam is impinged formed on the substrate in this order, the first recording layer and the second recording layer being formed so as to satisfy 0.8≦P0/P1≦1.2, where T is a light transmittance of the first recording layer, P0 is the minimum initialization energy of the laser beam per unit area required for crystallizing and initializing the recording film included in the first recording layer and P1 is the minimum initialization energy of the laser beam per unit area required for crystallizing and initializing the recording film included in the second recording layer.

In a preferred aspect of the present invention, the recording film included in the first recording layer and the recording film included in the second recording layer contain a phase change material as a primary component.

The above and other objects and features of the present invention will become apparent from the following description made with reference to the accompanying drawings.

### BRIEF DESCRIPTION OF THE DRAWINGS

FIG. 1 is a schematic cross-sectional view showing the structure of an optical recording medium whose recording films have been initialized by a recording film initializing apparatus.

FIG. 2 is a drawing showing a step of a method for fabricating an optical recording medium which is a preferred embodiment of the present invention.

FIG. 3 is a drawing showing a step of a method for fabricating an optical recording medium which is a preferred embodiment of the present invention.

FIG. 4 is a drawing showing a step of a method for fabricating an optical recording medium which is a preferred embodiment of the present invention.

FIG. 5 is a drawing showing a step of a method for fabricating an optical recording medium which is a preferred embodiment of the present invention.

FIG. 6 is a schematic view showing a recording film initialization apparatus which is a preferred embodiment of the present invention and is used for initializing recording films of an optical recording medium in an amorphous phase.

FIG. 7 is a schematic enlarged cross-sectional view of a portion indicated by A in FIG. 6.

FIG. 8 is a schematic view showing the shape of a spot S0 of a laser beam L formed in an L0 layer and the shape of a spot S1 of the laser beam L formed in an L1 layer.

FIG. 9 is a schematic enlarged cross-sectional view showing an optical recording medium irradiated with a laser beam.

FIG. 10 is a schematic enlarged cross-sectional view showing an optical recording medium irradiated with a laser beam.

### DESCRIPTION OF THE PREFERRED EMBODIMENTS

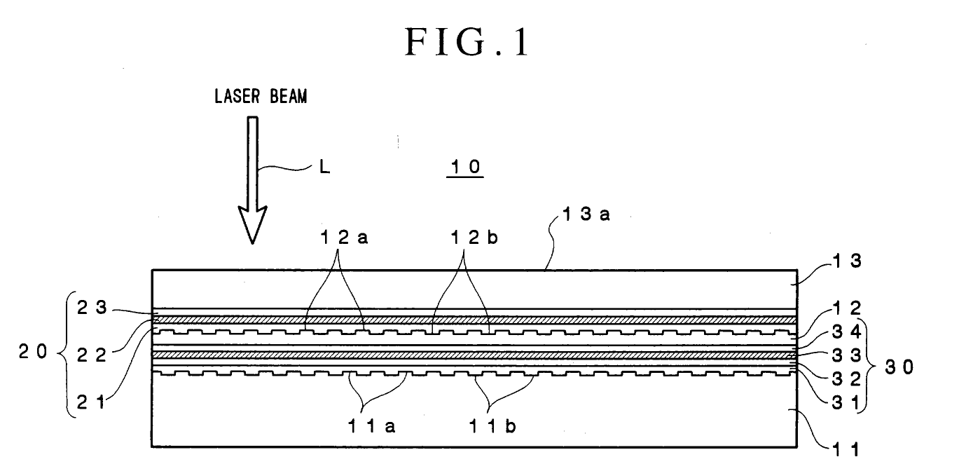

FIG. 1 is a schematic cross-sectional view showing the structure of an optical recording medium whose recording films have been initialized by a recording film initializing apparatus.

As shown in FIG. 1, an optical recording medium 10 according to this embodiment includes a disk-like support substrate 11, a transparent intermediate layer 12, a light transmission layer 13, an L0 layer 20 formed between the transparent layer 12 and the light transmission layer 13, and an L1 layer 30 formed between the support substrate 11 and the transparent intermediate layer 12.

The L0 layer 20 and the L1 layer 30 are recording layers in which data are recorded, i.e., the optical recording medium 10 according to this embodiment includes two recording layers.

The L0 layer 20 constitutes a recording layer close to the light transmission layer 13 and as shown in FIG. 1, the L0 layer 20 is constituted by laminating a second dielectric film 21, an L0 recording film 22 and a first dielectric film 23 from the side of the support substrate 11.

On the other hand, the L1 layer 30 constitutes a recording layer far from the light transmission layer 13 and as shown in FIG. 1, the L1 layer 30 is constituted by laminating a reflective film 31, a fourth dielectric film 32, an L1 recording film 33 and a third dielectric film 34.

The support substrate 11 serves as a support for ensuring mechanical strength required for the optical recording medium 10.

The material used to form the support substrate 11 is not particularly limited insofar as the support substrate 11 can serve as the support of the optical recording medium 10. The support substrate 11 can be formed of glass, ceramic, resin or the like. Among these, resin is preferably used for forming the support substrate 11 since resin can be easily shaped. Illustrative examples of resins suitable for forming the support substrate 11 include polycarbonate resin, acrylic resin, epoxy resin, polystyrene resin, polyethylene resin, polypropylene resin, silicone resin, fluoropolymers, acrylonitrile butadiene styrene resin, urethane resin and the like. Among these, polycarbonate resin is most preferably used for forming the support substrate 11 from the viewpoint of easy processing, optical characteristics and the like and in this embodiment, the support substrate 11 is formed of polycarbonate resin. In this embodiment, since the laser beam L is projected onto the L0 layer 20 and the L1 layer 30 via the light transmission layer 13 located opposite to the support substrate 11, it is unnecessary for the support substrate 11 to have a light transmittance property.

In this embodiment, the support substrate 11 has a thickness of about 1.1 mm.

As shown in FIG. 1, grooves 11a and lands 11b are alternately formed on the surface of the support substrate 11. The grooves 11a and/or lands 11b serve as a guide track for the laser beam L when data are to be recorded in the L1 layer 30 or when data are to be reproduced from the L1 layer 30.

The depth of the groove 11a is not particularly limited and is preferably set to 10 nm to 100 nm. The pitch of the grooves 11a is not particularly limited and is preferably set to 0.2 μm to 0.9 μm.

The transparent intermediate layer 12 serves to space the L0 layer 20 and the L1 layer 30 apart by a physically and optically sufficient distance.

As shown in FIG. 1, grooves 12a and lands 12b are alternately formed on the surface of the transparent intermediate layer 12. The grooves 12a and/or lands 12b formed on the surface of the transparent intermediate layer 12 serve as a guide track for the laser beam L when data are to be recorded in the L0 layer 20 or when data are to be reproduced from the L0 layer 20.

The depth of the groove 12a and the pitch of the grooves 12a can be set to be substantially the same as those of the grooves 11a formed on the surface of the support substrate 11.

It is preferable to form the transparent intermediate layer 12 so as to have a thickness of 5 μm to 50 μm and it is more preferable to form it so as to have a thickness of 10 μm to 40 μm.

The material for forming the transparent intermediate layer 12 is not particularly limited and an ultraviolet ray curable acrylic resin is preferably used for forming the transparent intermediate layer 12.

It is necessary for the transparent intermediate layer 12 to have sufficiently high light transmittance since the laser beam L passes through the transparent intermediate layer 12 when data are to be recorded in the L1 layer 30 and data recorded in the L1 layer 30 are to be reproduced.

The light transmission layer 13 serves to transmit the laser beam L and a light incident plane 13a is constituted by one of the surfaces thereof.

It is preferable to form the light transmission layer 13 so as to have a thickness of 30 μm to 200 μm.

The material for forming the light transmission layer 13 is not particularly limited and, similarly to the transparent intermediate layer 12, an ultraviolet ray curable acrylic resin is preferably used for forming the light transmission layer 13.

It is necessary for the light transmission layer 13 to have sufficiently high light transmittance since the laser beam L passes through the transparent intermediate layer 13 when data are to be recorded in the L1 layer 30 and data recorded in the L1 layer 30 are to be reproduced.

Each of the L0 recording film 22 of the L0 layer 20 and the L1 recording film 33 of the L1 layer 30 is formed of a phase change material. Utilizing the difference in the reflection coefficients between the case where the L0 recording film 22 and the L1 recording film 33 are in a crystal phase and the case where they are in an amorphous phase, data are recorded in the L0 recording film 23 and the L1 recording film 33 and data are reproduced from the L0 recording film 22 and the L1 recording film 33.

The material for forming the L0 recording film 22 and the L1 recording film 33 is not particularly limited but a material capable of changing from an amorphous phase to a crystal phase in a short time is preferable in order to enable direct overwriting of data at a high velocity. Illustrative examples of materials having such a characteristic include a SbTe system material.

As the SbTe system material, SbTe may be used alone or a SbTe system material to which additives are added in order to shorten time required for crystallization and improve the long-term storage reliability of the optical recording medium 10 may be used.

Concretely, it is preferable to form the L0 recording film 22 and the L1 recording film 33 of a SbTe system material represented by the compositional formula: (SbₓTe₁₋ₓ)_{1-y}M_{y}, where M is an element other than Sb and Te, x is equal to or larger than 0.55 and equal to or smaller than 0.9 and y is equal to or larger than 0 and equal to or smaller than 0.25, and it is more preferable to form the L0 recording film 22 and the L1 recording film 33 of a SbTe system material represented by the above mentioned compositional formula wherein x is equal to or larger than 0.65 and equal to or smaller than 0.85 and y is equal to or larger than 0 and equal to or smaller than 0.25.

While M is not particularly limited, it is preferable for the element M to be one or more elements selected from the group consisting of In, Ag, Au, Bi, Se, A1, P, Ge, H, Si, C, V, W, Ta, Zn, Mn, Ti, Sn, Pd, N, O and rare earth elements in order to shorten time required for crystallization and improve the storage reliability of the optical recording medium 10. It is particularly preferable for the element M to be one or more elements selected from the group consisting of Ag, In, Ge and rare earth elements for improving the storage reliability of the optical recording medium 10.

In the case where data are to be recorded in the L1 layer 30 and data recorded in the L1 layer 30 are to be reproduced, a laser beam L is projected thereon through the L0 layer 20 located closer to the light transmission layer 13. Therefore, it is necessary for the L0 layer 20 to have a high light transmittance.

As described later, in order to simultaneously crystallize and initialize the L0 recording film 22 of the L0 layer 20 and the L1 recording film 33 of the L1 layer 30, it is preferable to form the L0 layer 20 and the L1 layer 30 so that the following formula can be satisfied with the minimum initialization energy P0 of the laser beam L per unit time and unit area required for crystallizing and initializing the L0 recording film 22 of the L0 layer 20, the minimum initialization energy P1 of the laser beam L per unit time and unit area required for crystallizing and initializing the L1 recording film 33 of the L1 layer 30 and the light transmittance of the L0 layer 20.
0.8≦P0/P1≦1.2

The first dielectric film 23 and the second dielectric film 21 serve as protective layers for protecting the L0 recording film 22 and the third dielectric film 34 and the fourth dielectric film 32 serve as protective layers for protecting the L1 recording film 33.

The thickness of each of the first dielectric film 23, the second dielectric film 21, the third dielectric film 34 and the fourth dielectric film 32 is not particularly limited and it preferably has a thickness of 1 nm to 200 nm. In the case where the thickness of each of the first dielectric film 23, the second dielectric film 21, the third dielectric film 34 and the fourth dielectric film 32 is thinner than 1 nm, each of the first dielectric film 23, the second dielectric film 21, the third dielectric film 34 and the fourth dielectric film 32 does not sufficiently serve as a protective layer and is cracked during an initialization process described later and the characteristic (repeated overwriting characteristic) of the optical recording medium 10 when direct overwriting is repeated is degraded. On the other hand, in the case where the thickness of each of the first dielectric film 23, the second dielectric film 21, the third dielectric film 34 and the fourth dielectric film 32 exceeds 200 nm, a long time is required for forming it, thereby lowering the productivity of the optical recording medium 10 and there is some risk of cracking the L0 recording film 22 and the L1 recording film 33 due to internal stress.

The first dielectric film 23, the second dielectric film 21, the third dielectric film 34 and the fourth dielectric film 32 may have a single-layered structure or may have a multi-layered structure including a plurality of dielectric films. For example, if the first dielectric film 23 is constituted by two dielectric films formed of materials having different refractive indexes, light interference effect can be increased.

The material for forming the first dielectric film 23, the second dielectric film 21, the third dielectric film 34 and the fourth dielectric film 32 is not particularly limited but it is preferable to form the first dielectric film 23, the second dielectric film 21, the third dielectric film 34 and the fourth dielectric film 32 of oxide, sulfide, nitride of Al, Si, Ce, Zn, Ta, Ti and the like such as Al₂O₃, AlN, SiO₂, Si₃N₄, CeO₂, ZnS, TaO and the like or a combination thereof and it is more preferable for them to contain ZnS.SiO₂ as a primary component. ZnS SiO₂ means a mixture of ZnS and SiO₂.

The reflective film 31 included in the L1 layer 30 serves to reflect the laser beam L entering through the light incident plane 13a so as to emit it from the light incident plane 13a and effectively radiate heat generated in the L1 recording film 33 by the irradiation with the laser beam L.

The reflective film 31 is preferably formed so as to have a thickness of 20 nm to 200 nm. When the reflective film 31 is thinner than 20 nm, it does not readily radiate heat generated in the L1 recording film 33. On the other hand, when the reflective film 31 is thicker than 200 nm, the productivity of the optical recording medium 10 is lowered since a long time is required for forming the reflective film 31 and there is a risk of cracking the reflective film 31 due to internal stress or the like.

The material for forming the reflective film 31 is not particularly limited but the reflective film 31 is preferably formed of a metal having a high thermal conductivity such as Ag and Al and is more preferably formed of Ag. It is most preferable for the reflective film 31 to contain Ag as a primary component and a metal having a high corrosion resistance such as Au, Cu, Pt, Pd, Sb, Ti, Mg and the like as an additive.

The optical recording medium 10 having the above-described configuration can, for example, be fabricated in the following manner.

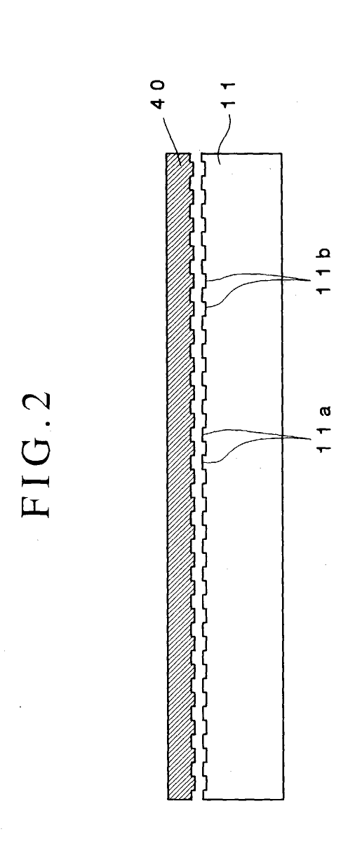

FIGS. 2 to 4 show the steps of a method for fabricating the optical recording medium 10 according to this embodiment.

As shown in FIG. 2, the support substrate 11 having grooves 11a and lands 11b on the surface thereof is first fabricated by an injection molding process using a stamper 40.

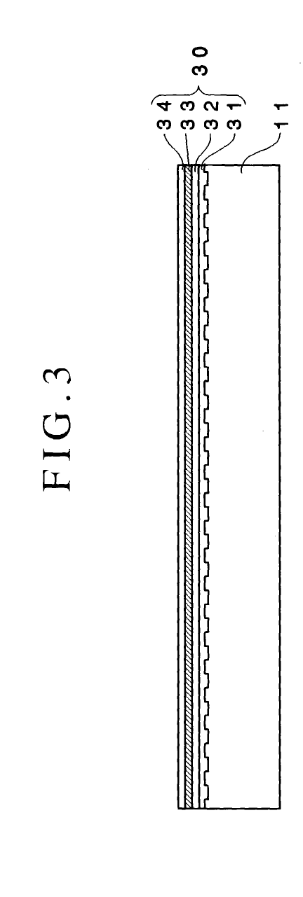

Then, as shown in FIG. 3, the reflective film 31, the fourth dielectric film 32, the L1 recording film 33 and the third dielectric film 34 are sequentially formed on the substantially entire surface of the support substrate 11 on which the grooves 11a and the lands 11b are formed by a gas phase growth process such as a sputtering process, thereby forming the L1 layer 30. The L1 recording film 33 is normally in an amorphous state immediately after formation by a sputtering process or the like.

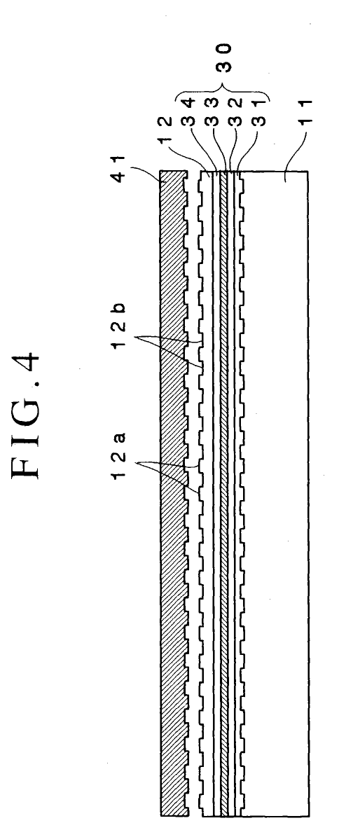

Further, as shown in FIG. 4, an ultraviolet ray curable resin is coated on the L1 layer 30 by a spin coating method to form a coating film and the surface of the coating film is irradiated with an ultraviolet ray via a stamper 41 while it is covered by the stamper 41, thereby forming the transparent intermediate layer 12 formed with grooves 12a and lands 12b on the surface thereof.

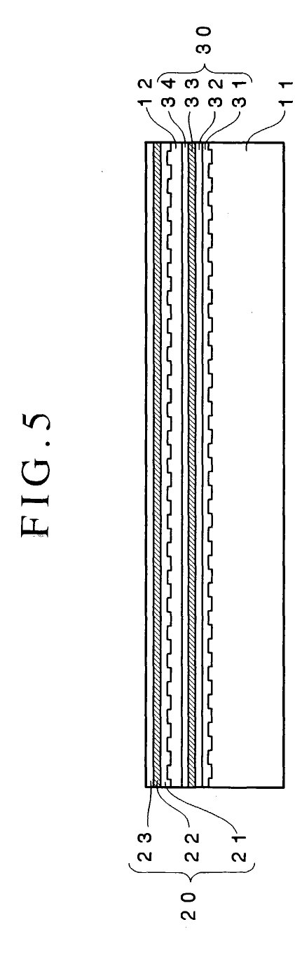

Then, as shown in FIG. 5, the second dielectric film 21, the L0 recording film 22 and the first dielectric film 23 are sequentially formed on substantially the entire surface of the transparent intermediate layer 12 on which the grooves 12a and the lands 12b are formed, by a gas phase growth process such as a sputtering process, thereby forming the L0 layer 20. The L0 recording film 22 is normally in an amorphous state immediately after formation by a sputtering process or the like.

An ultraviolet ray curable resin is further coated on the L0 layer 20 by a spin coating method to form a coating film and the surface of the coating film is irradiated with an ultraviolet ray, thereby forming the light transmission layer 13.

This completes the fabrication of the optical recording medium 10′ having the L0 recording film 23 and the L1 recording film 33 in an amorphous phase.

Since the L0 recording film 23 and the L1 recording film 33 of the thus fabricated optical recording medium 10′ are in an amorphous phase, prior to recording data in the L0 recording film 23 and the L1 recording film 33, an initialization processing is performed on the L0 recording film 23 and the L1 recording film 33, thereby crystallizing the L0 recording film 23 and the L1 recording film 33.

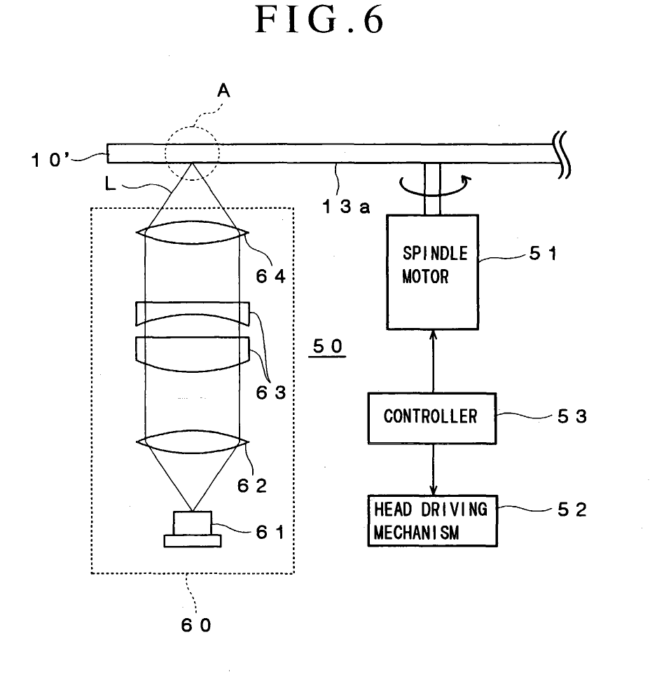

FIG. 6 is a schematic view showing a recording film initialization apparatus which is a preferred embodiment of the present invention and is used for initializing the L0 recording film 23 and the L1 recording film 33 of the optical recording medium 10′ in an amorphous phase.

As shown in FIG. 6, the recording film initialization apparatus 50 according to this embodiment includes a spindle motor 51 for rotating the optical recording medium 10′ including the L0 recording film 23 and the L1 recording film 33 in an amorphous phase, an optical head 60 for emitting a laser beam L toward the optical recording medium 10′, a head driving mechanism 52 for moving the optical head 60 in a direction perpendicular to the light incident plane 13a of the optical recording medium 10′ and in a radial direction of the optical recording medium 10′, and a controller 53 for controlling the operation of the spindle motor 51 and the head driving mechanism 52.

As shown in FIG. 6, the optical head 60 includes a semiconductor laser 61 for emitting a laser beam L, a collimator lens 62 for converting the laser beam L emitted from the semiconductor laser 61 into a parallel beam, a cylindrical lens system 63 for shaping the laser beam L transmitted through the collimator lens 62 into a substantially rectangular beam, and an objective lens 64 for converging the laser beam L transmitted through the cylindrical lens system 63 onto the optical recording medium 10′.

The power of the laser beam L emitted from the optical head 60 can be controlled within a predetermined range, for example, 1100 mW to 1350 mW.

The objective lens 64 preferably has a numerical aperture NA equal to or larger than 0.25, more preferably has a numerical aperture NA equal to or larger than 0.4 and most preferably has a numerical aperture NA equal to or larger than 0.6.

In this embodiment, the wavelength λ of the laser beam L and the numerical aperture NA of the objective lens 64 are selected so that the depth of focus D of the laser beam L converged by the objective lens 64 is smaller than the thickness d₁₂ of the transparent intermediate layer 12.

More specifically, when a laser beam L having a wavelength λ is converged by the objective lens 64 having a numerical aperture NA, the focus depth D is represented by λ/NA². In this embodiment, therefore, the wavelength λ of the laser beam L and the numerical aperture NA of the objective lens 64 are selected so that d₁₂ is preferably equal to or larger than λ/NA², more preferably equal to or larger than 2λ/NA² and most preferably equal to or larger than 4λ/NA².

When the L0 recording film 23 and the L1 recording film 33 of the optical recording medium 10′ are to be initialized, the optical recording medium 10′ including the L0 recording film 23 and the L1 recording film 33 in an amorphous phase is first set in the recording film initialization apparatus.

When the optical recording medium 10′ has been set in the recording film initialization apparatus, the controller 53 outputs a drive signal to the spindle motor 51, thereby causing it to rotate the optical recording medium 10′ and outputs a drive signal to the optical head 60, thereby causing it to activate the semiconductor laser 61.

As a result, a laser beam L is emitted from the semiconductor laser 61 toward the optical recording medium 10′ and is converted into a parallel beam by the collimator lens 62.

The laser beam L made a parallel beam advances to the cylindrical lens system 63, which shapes it into a substantially rectangular beam and is condensed by the objective lens 64 onto the optical recording medium 10′.

The controller 53 then outputs a drive signal to the head driving mechanism 52, thereby causing it to move the optical head 60 in a direction perpendicular to the light incident plane 13a of the optical recording medium 10′ so that the focus of the laser beam L coincides with a substantially center portion of the transparent intermediate layer 12 located between the L0 layer 20 and the L1 layer 30.

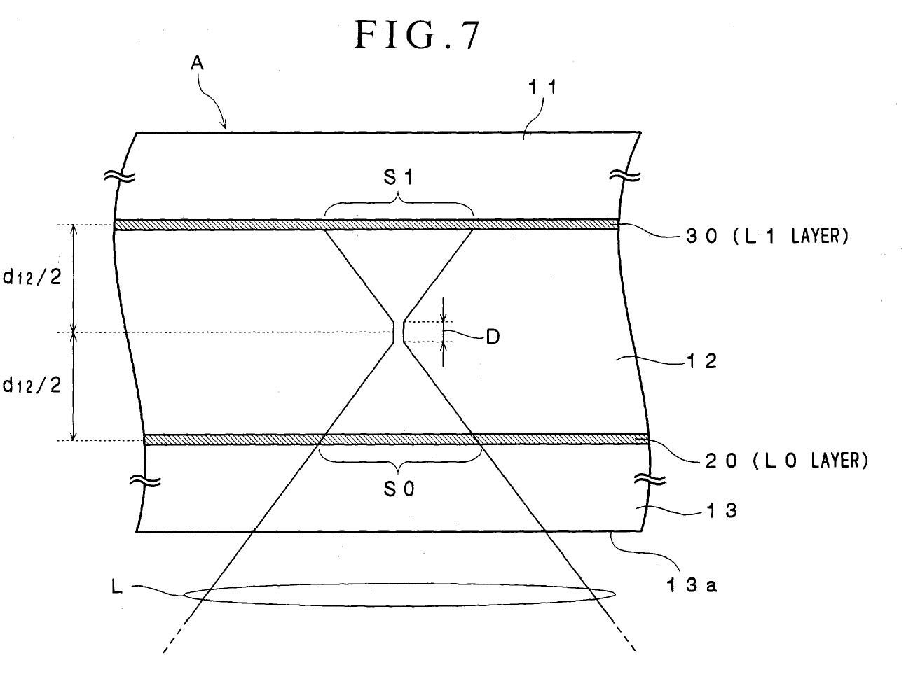

FIG. 7 is a schematic enlarged cross-sectional view of a portion indicated by A in FIG. 6.

As shown in FIG. 7, when the laser beam L is focused onto the substantially center portion of the transparent intermediate layer 12, spots S0 and S1 are formed in the L0 layer 20 and the L1 layer 30, respectively. In this embodiment, since the wavelength λ of the laser beam L and the numerical aperture NA of the objective lens 64 are selected so that the depth of focus D of the laser beam L is smaller than the thickness d₁₂ of the transparent intermediate layer 12, the spots S0 and S1 of the laser beam L are defocused.

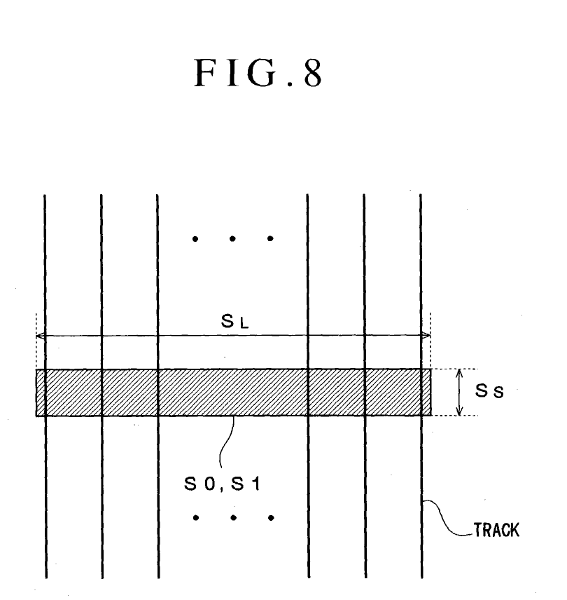

FIG. 8 is a schematic view showing the shape of the spot S0 of the laser beam L formed in the L0 layer (or the shape of the spot S1 of the laser beam L formed in the L1 layer).

As shown in FIG. 8, since the laser beam L is shaped into a substantially rectangular beam by the cylindrical lens system 63, the short edges Sₛ of the spots S0 and S1 extend in a direction that substantially coincides with the direction in which a track extends, namely, the circumferential direction of the optical recording medium 10′ and the long edges SL thereof extend in a direction that substantially coincides with a direction perpendicular to that in which the track extends, namely, the radial direction of the optical recording medium 10′.

As described above, since the laser beam L is shaped into a substantially rectangular beam by the cylindrical lens system 63, the length of the short edge of the spot S0 or the spot S1 of the laser beam L is longest when the spot S0 or the spot S1 is located at the focus of the laser beam L but the length of the long edge of the spot S0 or the spot S1 of the laser beam L is constant irrespective of the position of the focus of the laser beam L.

Therefore, as shown in FIG. 8, the laser beam L is projected onto a predetermined number of tracks of the L0 layer 20 and the L1 layer 30.

Further, the laser beam L is projected onto the L1 layer 30 via the L0 layer 20 and the transparent intermediate layer 12. Therefore, assuming that the light transmittance of the transparent intermediate layer 12 is 100%, the relationship between the energy P_{L0} of the laser beam L projected onto the spot S0 of the L0 layer 20 per unit time, the energy P_{L1} of the laser beam L projected onto the spot S1 of the L1 layer 30 per unit time and the light transmittance T of the L0 layer 20 is expressed by the following formula (1).
P_{L1}=T×P_{L0} (1)

In the above formula, each of the energy P_{L0} and the energy P_{L1} is a function of the power of the laser beam L.

On the other hand, the following formula (2) has to be satisfied for irradiating the L0 recording film 22 of the L0 layer 20 with the laser beam L, thereby crystallizing and initializing it, where P0 is the minimum initialization energy of the laser beam L per unit time and unit area required for crystallizing and initializing the L0 recording film 22 of the L0 layer 20.
P_{L0}/A0≧P0 (2)

In the above formula, A0 designates the area of the spot S0 and is a function of the position of the focus of the laser beam L.

Similarly, the following formula (3) has to be satisfied for irradiating the L1 recording film 33 of the L1 layer 30 with the laser beam L, thereby crystallizing and initializing it, where P1 is the minimum initialization energy of the laser beam L per unit time and unit area required for crystallizing and initializing the L1 recording film 33 of the L1 layer 30!
P_{L1}/A1=T×P_{L0}/A1≧P1 (3)

In the above formula, A1 designates the area of the spot S1 and is a function of the position of the focus of the laser beam L.

Therefore, if the laser beam L can be projected onto the L0 recording film 33 of the L0 layer 20 and the L1 recording film 33 of the L1 layer 30 so as to simultaneously satisfy the formulae (2) and (3), the L0 recording film 33 of the L0 layer 20 and the L1 recording film 33 of the L1 layer 30 can be simultaneously crystallized and initialized.

Since each of the energy P_{L0} of the laser beam L projected onto the spot S0 of the L0 layer 20 per unit time and the energy P_{L1} of the laser beam L projected onto the spot S1 of the L1 layer 30 per unit time is a function of the power of the laser beam L emitted from the semiconductor laser 61, the energy P_{L0} and the energy P_{L1} can be increased by setting the power of the laser beam L to be a higher level. On the other hand, each of the area A0 of the spot S0 of the laser beam L and the area A1 of the spot S1 of the laser beam L is a function of the position of the focus of the laser beam L. Therefore, the L0 recording film 33 of the L0 layer 20 and the L1 recording film 33 of the L1 layer 30 can be simultaneously crystallized and initialized by controlling the power of the laser beam L and the position of the focus of the laser beam L.

More specifically, if both of the formulae (2) and (3) are not satisfied when the laser beam L is projected onto the optical recording medium 10′ at a certain power and with the focus thereof located at the position shown in FIG. 8, it can be considered that the power of the laser beam L is too low and the L0 recording film 33 of the L0 layer 20 and the L1 recording film 33 of the L1 layer 30 cannot be simultaneously crystallized and initialized even if the position of the focus of the laser beam L is adjusted. The power of the laser beam L is therefore set to a higher level.

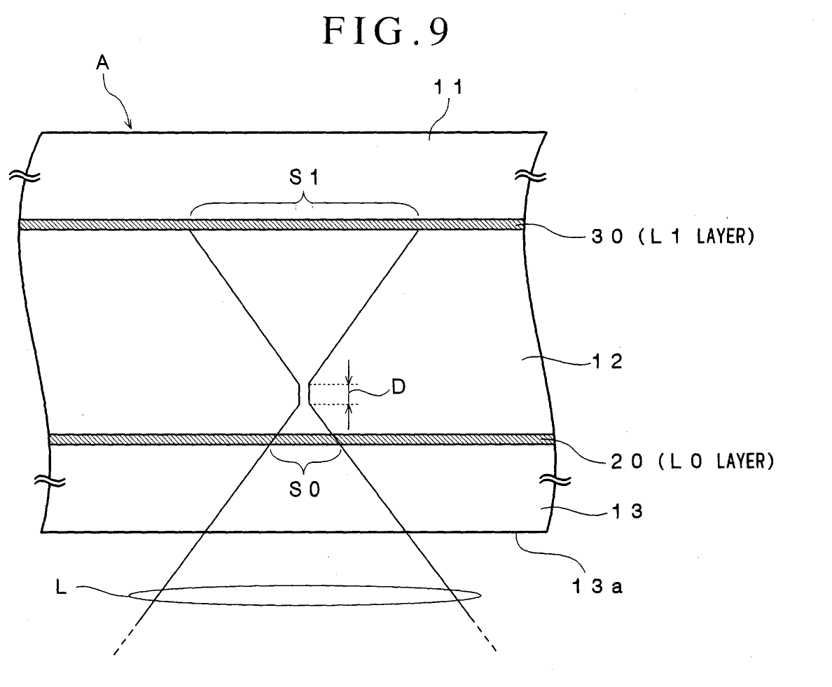

If after the power of the laser beam L has been set to a higher level, the formula (3) is satisfied but the formula (2) is not still satisfied, it can be considered that the energy P_{L1}/A1 of the laser beam L projected onto the unit area of the L1 recording film 33 of the L1 layer 30 per unit time has increased to equal or higher than the minimum initialization energy P1 of the L1 recording film 33 and the L1 recording film 33 of the L1 layer 30 can be crystallized and initialized but that the energy P_{L0}/A0 of the laser beam L projected onto the unit area of the L0 recording film 22 of the L0 layer 20 per unit time is still lower than the minimum initialization energy P0 of the L0 recording film 22 and the L0 recording film 22 of the L0 layer 20 cannot be crystallized and initialized. Therefore, as shown in FIG. 9, the optical head 60 is moved in a direction perpendicular to the light incident plane 13a of the optical recording medium 10′ so as to locate the focus of the laser beam L at a position closer to the L0 layer 20.

As a result, as shown in FIG. 9, the area A0 of the spot S0 of the laser beam L formed in the L0 layer 20 decreases and the energy P_{L0}/A0 of the laser beam L projected onto the unit area of the L0 recording film 22 of the L0 layer 20 per unit time increases, while the area A1 of the spot S1 of the laser beam L formed in the L1 layer 30 increases and the energy P_{L1}/A1 of the laser beam L projected onto the unit area of the L1 recording film 33 of the L1 layer 30 per unit time decreases.

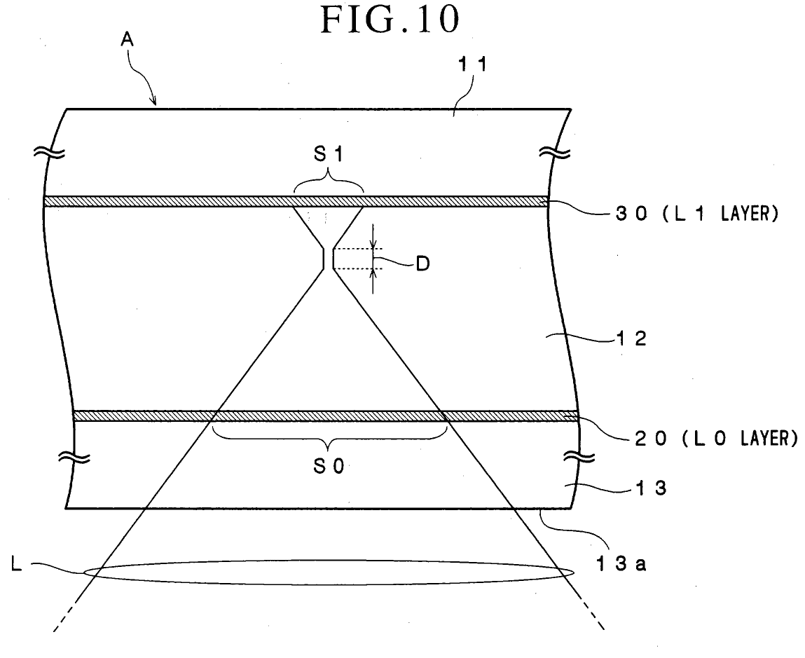

To the contrary, if after the power of the laser beam L has been set to a higher level the formula (2) is satisfied but the formula (3) is not still satisfied, it can be considered that the energy P_{L0}/A0 of the laser beam L projected onto the unit area of the L0 recording film 22 of the L0 layer 20 per unit time has increased to be equal to or higher than the minimum initialization energy P0 of the L0 recording film 22 and the L0 recording film 22 of the L0 layer 20 can be crystallized and initialized but that the energy P_{L1}/A1 of the laser beam L projected onto the unit area of the L1 recording film 33 of the L1 layer 30 per unit time is still lower than the minimum initialization energy P1 of the L1 recording film 33 and the L1 recording film 33 of the L1 layer 30 cannot be crystallized and initialized. Therefore, as shown in FIG. 10, the optical head 60 is moved in a direction perpendicular to the light incident plane 13a of the optical recording medium 10′ so as to locate the focus of the laser beam L at a position closer to the L1 layer 30.

As a result, as shown in FIG. 10, the area A1 of the spot S1 of the laser beam L formed in the L1 layer 30 decreases and the energy P_{L1}/A1 of the laser beam L projected onto the unit area of the L1 recording film 33 of the L1 layer 30 per unit time increases, while the area A0 of the spot S0 of the laser beam L formed in the L0 layer 20 increases and the energy P_{L0}/A0 of the laser beam L projected onto the unit area of the L0 recording film 22 of the L0 layer 20 per unit time decreases.

Therefore, if the light transmittance T of the L0 layer 20, the minimum initialization energy P0 of the laser beam L per unit time and unit area required for crystallizing and initializing the L0 recording film 22 of the L0 layer 20, the minimum initialization energy P1 of the laser beam L per unit time and unit area required for crystallizing and initializing the L1 recording film 33 of the L1 layer 30 and the light transmittance of the light transmission layer 13 are obtained in advance and stored in a memory (not shown) of the recording film initialization apparatus 50 for each kind of optical recording media 10′ and the kind of the optical recording medium 10′ is input to the recording film initialization apparatus 50 when the recording film initialization is to be conducted, the controller 53 can read data corresponding to the input kind of the optical recording medium 10′ among the data stored in the memory and determine the optimum power of the laser beam L and the optimum position of the focus of the laser beam L in the transparent intermediate layer 12, namely, the optimum position of the optical head 60 in the direction perpendicular to the light incident plane 13a of the optical recording medium 10′ based on the thus read data. Therefore, the L0 recording film 33 of the L0 layer 20 and the L1 recording film 33 of the L1 layer 30 can be simultaneously crystallized and initialized by irradiating the L0 recording film 33 and the L1 recording film 33 with the laser beam L.

As described above, the minimum initialization energy P0 of the laser beam L per unit time and unit area required for crystallizing and initializing the L0 recording film 22 of the L0 layer 20 and the minimum initialization energy P1 of the laser beam L per unit time and unit area required for crystallizing and initializing the L1 recording film 33 of the L1 layer 30 are controlled by adjusting the position of the focus of the laser beam L in the transparent intermediate layer 12, thereby simultaneously crystallizing and initializing the L0 recording film 22 of the L0 layer 20 and the L1 recording film 33 of the L1 layer 30. Therefore, in a case where the difference between the minimum initialization energy P0 of the L0 recording film 22 and the minimum initialization energy P1 of the L1 recording film 33 is too large, it becomes difficult to adjust the position of the focus of the laser beam L in the transparent intermediate layer 12 to one that controls the energy P_{L0}/A0 of the laser beam L projected onto the unit area of the L0 recording film 22 of the L0 layer 20 per unit time to be equal to or higher than the minimum initialization energy P0 of the L0 recording film 22 and controls the energy P_{L1}/A1 of the laser beam L projected onto the unit area of the L1 recording film 33 of the L1 layer 30 per unit time to be equal to or higher than the minimum initialization energy P1 of the L1 recording film 33. Therefore, it is preferable to form the L0 layer 20 and the L1 layer 30 so that the minimum initialization energy P0 of the laser beam L per unit time and unit area required for crystallizing and initializing the L0 recording film 22 of the L0 layer 20, the minimum initialization energy P1 of the laser beam L per unit time and unit area required for crystallizing and initializing the L1 recording film 33 of the L1 layer 30, and the light transmittance of the L0 layer 20 are such that the following formula is satisfied.
0.8≦P0/P1≦1.2

In this embodiment, since the L0 recording film 22 of the L0 layer 20 and the L1 recording film 33 of the L1 layer 30 contain the same phase change material and have the same composition, the minimum initialization energy P0 of the laser beam L per unit time and unit area required for crystallizing and initializing the L0 recording film 22 of the L0 layer 20 and the minimum initialization energy P1 of the laser beam L per unit time and unit area required for crystallizing and initializing the L1 recording film 33 of the L1 layer 30 are substantially equal to each other. Therefore, the L0 recording film 33 of the L0 layer 20 and the L1 recording film 33 of the L1 layer 30 can be simultaneously crystallized and initialized by determining the power of the laser beam L and the position of the optical head 60 in the direction perpendicular to the light incident plane 13a of the optical recording medium 10′ so that the energy P_{L0} projected onto the spot S0 of the L0 recording film 33 and the position of the focus of the laser beam L satisfy the formulae (2) and (4).
P_{L0}/A0≧P0 (2)
T×P_{L0}/A1≧P0 (4)

When the power of the laser beam L emitted from the semiconductor laser 61 and the position of the optical head 60 in the direction perpendicular to the light incident plane 13a of the optical recording medium 10′ have been determined in the above described manner, the operation for initializing the L0 recording film 22 of the L0 layer 20 and the L1 recording film 33 of the L1 layer 30 is started and the controller 53 outputs a drive signal to the spindle motor 51, thereby causing it to rotate the optical recording medium 10′ and outputs a drive signal to the optical head 60 to activate the semiconductor laser 61, thereby causing it to emit the laser beam L toward the optical recording medium 10′.

The controller 53 thereafter outputs a drive signal to the head driving mechanism 52 every time the optical recording medium 10′ is rotated by one revolution, thereby causing the head driving mechanism 52 to move the optical head 60 in a direction perpendicular to the longitudinal direction of the tracks of the optical recording medium 10′.

As a result, the entire surfaces of the L0 recording film 22 of the L0 layer 20 and the L1 recording film 33 of the L1 layer 30 are simultaneously crystallized and initialized.

As described above, the laser beam L is shaped into a substantially rectangular beam whose long edge SL extends in a direction perpendicular to the longitudinal direction of the track and is projected onto the optical recording medium 10′ and, irrespective of the position of the focus of the laser beam L, the laser beam L is projected onto a predetermined number of tracks of the L0 layer 20 and the L1 layer 30. Therefore, the entire surfaces of the L0 recording film 22 of the L0 layer 20 and the L1 recording film 33 of the L1 layer 30 can be simultaneously crystallized and initialized with the laser beam L by moving the optical head 60 in a direction perpendicular to the longitudinal direction of the tracks of the optical recording medium 10′ every time the optical recording medium 10′ is rotated by one revolution.

Further, since the laser beam L is defocused in the L0 layer 20 and the L1 layer 30, the power of the laser beam L does not abruptly change at the peripheral edge portions of the spot S0 and the spot S1. Therefore, after a certain track group has been initialized with the laser beam L and the optical head 60 is moved in a direction perpendicular to the longitudinal direction of the tracks of the optical recording medium 10′ to initialize the next track group with the laser beam L, it is possible to effectively prevent an uneven region from being formed between initialized regions.

It is possible to judge whether or not the L0 recording film 22 of the L0 layer 20 and the L1 recording film 33 of the L1 layer 30 have been initialized in a desired manner by projecting a laser beam L having a power whose level is substantially the same as that of a reproducing power onto the L0 layer 20 and the L1 layer 30 before and after the initialization process and measuring the change in the reflection coefficients of the L0 layer 20 and the L1 layer 30.

When the initialization process for the L0 recording film 22 of the L0 layer 20 and the L1 recording film 33 of the L1 layer 30 has been completed in this manner, there is obtained an optical recording medium 10 in which the L0 recording film 22 of the L0 layer 20 and the L1 recording film 33 of the L1 layer 30 have been crystallized.

When data are to be recorded in the thus fabricated optical recording medium 10, the light incident plane 13a of the light transmission layer 13 is irradiated with a laser beam L whose intensity is modulated and the focus of the laser beam L is adjusted onto the L0 recording film 22 of the L0 layer 20 or the L1 recording film 33 of the L1 layer 30.

When a predetermined region of the L0 recording film 22 of the L0 layer 20 or the L1 recording film 33 of the L1 layer 30 is heated by the irradiation with the laser beam L to a temperature equal to or higher than the melting point of the phase change material and quickly cooled, the region assumes an amorphous state. On the other hand, when a predetermined region of the L0 recording film 22 of the L0 layer 20 or the L1 recording film 33 of the L1 layer 30 is heated by the irradiation with the laser beam L to a temperature equal to or higher than the crystallization temperature of the phase change material and gradually cooled, the region assumes a crystallized state. A record mark is formed by the region in the amorphous state of the L0 recording film 22 of the L0 layer 20 or the L1 recording film 33 of the L1 layer 30. The length of the record mark and the length of the blank region between the record mark and the neighboring record mark in the direction of the track constitute data recorded in the L0 recording film 22 of the L0 layer 20 or the L1 recording film 33 of the L1 layer 30.

On the other hand, when data recorded in the optical recording medium 10 are to be reproduced, the light incident plane 13a of the light transmission layer 13 is irradiated with a laser beam L whose intensity is modulated and the focus of the laser beam L is adjusted onto the L0 recording film 22 of the L0 layer 20 or the L1 recording film 33 of the L1 layer 30.

Since the reflection coefficients of the L0 recording film 22 of the L0 layer 20 or the L1 recording film 33 of the L1 layer 30 are different between a region in an amorphous state and a region in a crystallized state, it is possible to reproduce data recorded in the L0 recording film 22 of the L0 layer 20 or the L1 recording film 33 of the L1 layer 30 by detecting the amount of light reflected from the L0 recording film 22 or the L1 recording film 33.

According to this embodiment, since the L0 recording film 22 of the L0 layer 20 and the L1 recording film 33 of the L1 layer 30 are simultaneously crystallized and initialized only by setting the power of the laser beam L and the position of the focus of the laser beam L in the transparent intermediate layer 12 so that the energy P_{L0}/A0 of the laser beam L projected onto the unit area of the L0 recording film 22 of the L0 layer 20 per unit time is equal to or higher than the minimum initialization energy P0 of the L0 recording film 22 and the energy P_{L1}/A1 of the laser beam L projected onto the unit area of the L1 recording film 33 of the L1 layer 30 per unit time is equal to or higher than the minimum initialization energy P1 of the L1 recording film 33 and projecting the laser beam L onto the L0 layer 20 and the L1 layer 30 of the optical recording medium 10′, the L0 recording film 22 of the L0 layer 20 and the L1 recording film 33 of the L1 layer 30 can be efficiently simultaneously crystallized and initialized using the recording film initialization apparatus of simple structure.

Further, according to this embodiment, the memory of the recording film initialization apparatus 50 stores the light transmittance T of the L0 layer 20, the minimum initialization energy P0 of the laser beam L per unit time and unit area required for crystallizing and initializing the L0 recording film 22 of the L0 layer 20, the minimum initialization energy P1 of the laser beam L per unit time and unit area required for crystallizing and initializing the L1 recording film 33 of the L1 layer 30 and the light transmittance of the light transmission layer 13 for each kind of optical recording media 10′ and the controller 53 is constituted so as to read data corresponding to the kind of the optical recording medium 10′ input to the recording film initialization apparatus 50 among the data stored in the memory when the recording film initialization is to be conducted, determine the optimum power of the laser beam L and the optimum position of the focus of the laser beam L in the transparent intermediate layer 12, move the optical head 60 in a direction perpendicular to the light incident plane 13a to locate it at the optimum position and cause the semiconductor laser 61 to emit the laser beam L toward the optical recording medium 10′. Therefore, it is possible to simultaneously crystallize and initialize the L0 recording film 22 of the L0 layer 20 and the L1 recording film 33 of the L1 layer 30 only by inputting the kind of the optical recording medium 10′ to the recording film initialization apparatus 50.

The present invention has thus been shown and described with reference to specific embodiments. However, it should be noted that the present invention is in no way limited to the details of the described arrangements but changes and modifications may be made without departing from the scope of the appended claims.

For example, in the above described embodiment, although the optical recording medium 10 includes the L0 recording film 22 and the L1 recording film 33 containing a SbTe system material, it is not absolutely necessary for the optical recording medium 10 to include the L0 recording film 22 and the L1 recording film 33 containing a SbTe system material and the optical recording medium 10 may include an L0 recording film and an L1 recording film containing another phase change material.

Further, in the above described embodiment, although the L0 recording film 22 and the L1 recording film 33 contain the same phase change material and have the same composition, it is not absolutely necessary for the L0 recording film 22 and the L1 recording film 33 to contain the same phase change material and have the same composition, and the L0 recording film 22 and the L1 recording film 33 may have different compositions.

Furthermore, in the above described embodiment, although the optical recording medium 10 includes the L0 layer 20 and the L1 layer 30, namely, two recording layers, it is not absolutely necessary for the optical recording medium to include two recording layers and the optical recording medium may include three or more recording layers. In such a case, when the recording film initialization is to be conducted, the laser beam L is defocused on every recording layer.

Moreover, in the above described embodiment, although the second dielectric film 21 is formed on the transparent intermediate layer 12, it is possible to provide a semitransparent film between the transparent intermediate layer 12 and the second dielectric film 21 for improving the reproduction output of data recorded in the L0 layer 20 and preventing the transparent intermediate layer 12 from being damaged by heat when data are recorded in the L0 layer 20. It is further possible to provide a base protection film between the semitransparent film and the transparent intermediate layer 12, thereby physically spacing the semitransparent film and the transparent intermediate layer 12.

Further, in the above described embodiment, although the light transmission layer 13 is formed on the surface of the first dielectric film 23 of the L0 layer 20, it is possible to provide a transparent heat radiation film having a thickness of 10 nm t0 200 nm and made of a material having higher thermal conductivity than that of the material forming the first dielectric film 23 between the first dielectric film 23 of the L0 layer 20 and the light transmission layer 13 in order to improve heat radiation characteristics of the L0 layer 20 and it is further possible to provide a dielectric film having a different refractive index from that of the transparent heat radiation film between the transparent heat radiation film and the light transmission layer 13 in order to increase light interference effect.

Furthermore, in the above described embodiment, although the reflective film 31 is formed on the support substrate 11, a moisture resistant film may be provided between the reflective film 31 and the support substrate 11.

According to the present invention, it is possible to provide a method and apparatus for initializing recording films of an optical recording medium which can efficiently simultaneously crystallize and initialize recording films of a plurality of recording layers of an optical recording medium with an apparatus of simple structure and an optical recording medium adapted so that recording films of a plurality of recording layers can be simultaneously crystallized and initialized.

1. A method for initializing recording films of an optical recording medium including a plurality of recording layers each including a recording film and which is formed so that a transparent intermediate layer is interposed between each adjacent pair of the recording layers, by projecting a laser beam whose power can be controlled within a predetermined range onto the recording films and simultaneously crystallizing and initializing the recording films, the method for initializing recording films of an optical recording medium comprising steps of setting a power of the laser beam and a position of a focus of the laser beam so that energy of the laser beam projected onto each of the recording films is equal to or higher than a minimum initialization energy which can crystallize and initialize the recording film irradiated with the laser beam, and projecting the laser beam onto the recording films of the optical recording medium.

2. A method for initializing recording films of an optical recording medium in accordance with claim 1 wherein the laser beam is focused so that the focus thereof is located in a transparent intermediate layer.

3. A method for initializing recording films of an optical recording medium in accordance with claim 2 wherein the laser beam is condensed by an objective lens onto a transparent intermediate layer to have a depth of focus D so that d≧λ/NA² is satisfied, where d is a thickness of the transparent intermediate layer, λ is a wavelength of the laser beam and NA is a numerical aperture of the objective lens.

4. A method for initializing recording films of an optical recording medium in accordance with claim 2 wherein the optical recording medium includes a first recording layer formed close to a light incident plane on which the laser beam is impinged, a second recording layer formed far from the light incident plane and a transparent intermediate layer formed between the first recording layer and the second recording layer and which comprises steps of setting the power of the laser beam and the position of the focus of the laser beam so as to satisfy P_{L0}/A0≧P0 and T×P_{L0}/A1≧P1, where P_{L0} is the energy of the laser beam projected onto the first recording layer, A0 is an area of a spot of the laser beam projected onto the first recording layer, A1 is an area of a spot of the laser beam projected onto the second recording layer, T is a light transmittance of the first recording layer, P0 is the minimum initialization energy of the laser beam per unit area required for crystallizing and initializing a recording film included in the first recording layer and P1 is the minimum initialization energy of the laser beam per unit area required for crystallizing and initializing a recording film included in the second recording layer, and projecting the laser beam onto the first recording layer and the second recording layer of the optical recording medium.

5. A method for initializing recording films of an optical recording medium in accordance with claim 3 wherein the optical recording medium includes a first recording layer formed close to a light incident plane on which the laser beam is impinged, a second recording layer formed far from the light incident plane and a transparent intermediate layer formed between the first recording layer and the second recording layer and which comprises steps of setting the power of the laser beam and the position of the focus of the laser beam so as to satisfy P_{L0}/A0≧P0 and T×P_{L0}/A1≧P1, where P_{L0} is the energy of the laser beam projected onto the first recording layer, A0 is an area of a spot of the laser beam projected onto the first recording layer, A1 is an area of a spot of the laser beam projected onto the second recording layer, T is a light transmittance of the first recording layer, P0 is the minimum initialization energy of the laser beam per unit area required for crystallizing and initializing a recording film included in the first recording layer and P1 is the minimum initialization energy of the laser beam per unit area required for crystallizing and initializing a recording film included in the second recording layer, and projecting the laser beam onto the first recording layer and the second recording layer of the optical recording medium.

6. An apparatus for initializing recording films of an optical recording medium including a plurality of recording layers each including a recording film and which is formed so that a transparent intermediate layer is interposed between each adjacent pair of the recording layers, by projecting a laser beam onto the recording films and simultaneously crystallizing and initializing the recording films, the apparatus for initializing recording films of an optical recording medium comprising a semiconductor laser adapted for emitting a laser beam and movable in a direction perpendicular to a surface of the optical recording medium, an objective lens for converging the laser beam and a controller for controlling overall operation of the apparatus for initializing recording films of an optical recording medium, the controller being constituted so as to set a power of the laser beam emitted from the semiconductor laser and a position of the semiconductor laser in the direction perpendicular to the surface of the optical recording medium so that energy of the laser beam projected onto each of the recording films is equal to or higher than a minimum initialization energy which can crystallize and initialize the recording film irradiated with the laser beam, and projecting the laser beam onto the recording films of the optical recording medium.

7. An apparatus for initializing recording films of an optical recording medium in accordance with claim 6 wherein the controller is constituted so as to set the position of the semiconductor laser in the direction perpendicular to the surface of the optical recording medium so that the focus of the laser beam is located in a transparent intermediate layer.

8. An apparatus for initializing recording films of an optical recording medium in accordance with claim 7 wherein the semiconductor laser and the objective lens are selected to produce a depth of focus D so that d≧λ/NA² is satisfied, where d is a thickness of the transparent intermediate layer, λ is a wavelength of the laser beam and NA is a numerical aperture of the objective lens.

9. An apparatus for initializing recording films of an optical recording medium in accordance with claim 7 wherein the optical recording medium includes a first recording layer formed close to a light incident plane on which the laser beam is impinged, a second recording layer formed far from the light incident plane and a transparent intermediate layer formed between the first recording layer and the second recording layer and which further comprises a memory for storing, for each kind of the optical recording media, a light transmittance T1 of the first recording layer, the minimum initialization energy P0 of the laser beam per unit area required for crystallizing and initializing a recording film included in the first recording layer, the minimum initialization energy P1 of the laser beam per unit area required for crystallizing and initializing a recording film included in the second recording layer and a light transmittance T2 of the optical recording medium between the light incident plane and the first recording layer, the controller being constituted so as to set the power of the laser beam emitted from the semiconductor laser and the position of the semiconductor laser in the direction perpendicular to the light incident plane so as to satisfy T2×P/A0≧P0 and T1×T2×P/A1≧P1, where P is the power of the laser beam emitted from the semiconductor laser, A0 is an area of a spot of the laser beam projected onto the first recording layer and A1 is an area of a spot of the laser beam projected onto the second recording layer.

10. An apparatus for initializing recording films of an optical recording medium in accordance with claim 8 wherein the optical recording medium includes a first recording layer formed close to a light incident plane on which the laser beam is impinged, a second recording layer formed far from the light incident plane and a transparent intermediate layer formed between the first recording layer and the second recording layer and which further comprises a memory for storing, for each kind of the optical recording media, a light transmittance T1 of the first recording layer, the minimum initialization energy P0 of the laser beam per unit area required for crystallizing and initializing a recording film included in the first recording layer, the minimum initialization energy P1 of the laser beam per unit area required for crystallizing and initializing a recording film included in the second recording layer and a light transmittance T2 of the optical recording medium between the light incident plane and the first recording layer, the controller being constituted so as to set the power of the laser beam emitted from the semiconductor laser and the position of the semiconductor laser in the direction perpendicular to the light incident plane so as to satisfy T2×P/A0≧P0 and T1×T2×P/A1≧P1, where P is the power of the laser beam emitted from the semiconductor laser, A0 is an area of a spot of the laser beam projected onto the first recording layer and A1 is an area of a spot of the laser beam projected onto the second recording layer.

11. An optical recording medium comprising a substrate, and a second recording layer including a recording film, a transparent intermediate layer, a first recording layer including a recording film and a light transmission layer on which a laser beam is impinged formed on the substrate in this order, the first recording layer and the second recording layer being formed so as to satisfy 0.8≦P0/P1≦1.2, where T is a light transmittance of the first recording layer, P0 is the minimum initialization energy of the laser beam per unit area required for crystallizing and initializing the recording film included in the first recording layer and P1 is the minimum initialization energy of the laser beam per unit area required for crystallizing and initializing the recording film included in the second recording layer.

12. An optical recording medium in accordance with claim 11 wherein the recording film included in the first recording layer and the recording film included in the second recording layer contain a phase change material as a primary component.
